(19) United States
(12) Patent Application Publication
(10) Pub. No.: US 2025/0358091 A1
(43) Pub. Date: Nov. 20, 2025

(54) DIE-TO-DIE INTERFACE USING SIMULTANEOUS BIDIRECTIONAL LINKS ON AN INTERPOSER

(71) Applicant: NVIDIA Corporation, Santa Clara, CA (US)

(72) Inventor: Ish Chadha, San Jose, CA (US)

(21) Appl. No.: 18/668,724

(22) Filed: May 20, 2024

(51) Int. Cl. H04L 7/00; H04L 7/033

(52) U.S. Cl. CPC H04L 7/0016; H04L 7/0079; H04L 7/033

(57) ABSTRACT

A first device includes a transceiver to communicate with a second device over an interposer, the interposer comprising a plurality of conductive traces between the first device and the second device. The first device also includes control logic, coupled to the transceiver associated with the first device, configured to send first data to the second device over a conductive trace of the plurality of conductive traces, simultaneously receive second data from the second device over the conductive trace, and extract the second data from a combined signal comprising the first data and the second data.

### TECHNICAL FIELD

At least one implementation generally pertains to communications systems, and more specifically, but not exclusively, to a die-to-die interface using simultaneous bidirectional links on an interposer.

### BACKGROUND

Data can be processed by multiple coupled integrated circuits (ICs) that may each perform different, sometimes specialized, functions. Often these ICs are colloquially referred to as ‘die,’ with reference to the final stages of the semiconductor manufacturing process where the ICs (e.g., the dies) are cut from a larger semiconductor wafer. Thus, a “die-to-die interface” can describe a set of channels between two dies that are assembled in the same device package.

### BRIEF DESCRIPTION OF DRAWINGS

Various implementations in accordance with the present disclosure will be described with reference to the drawings, in which:

FIG. 1A is a schematic block diagram showing a schematic cross-sectional view of a communications system configured to implement simultaneous bi-directional (SBD) data lanes, according to various implementations.

FIG. 1B is a schematic block diagram showing a top view of communications system 100, according to various implementations.

FIG. 2 is a schematic block diagram of an example simultaneous bi-directional (SBD) communications system according to various implementations.

FIGS. 3A-3B are graphs that illustrate example extraction operations performed by respective splitters, according to some implementations.

FIG. 4 is a flow chart of an example method for operating a sideband link, in accordance with one or more aspects of the present disclosure.

FIG. 5 is a block diagram illustrating an exemplary computer system which can be a system with interconnected devices and components, a system-on-a-chip (SOC), or some combination thereof, in accordance with one or more aspects of the present disclosure.

FIG. 6 is a block diagram illustrating an electronic device for utilizing a processor, in accordance with one or more aspects of the present disclosure.

FIG. 7 is a block diagram of a processing system, in accordance with one or more aspects of the present disclosure.

### DETAILED DESCRIPTION

A device package can include two or more dies (also referred to as integrated circuits (IC) or chips) mounted on an interposer or a similar high-bandwidth interconnect. These interconnects include very small and high-density conductive traces that form data lanes (also referred to as channels) between the multiple dies. The conductive traces (e.g., wires, conductive layers, etc.) carry input/output (I/O) signals between two dies (via respective I/O pins or pads connected to the conductive trace and each die) and each data lane provides a high-speed pathway for communication between the two dies (e.g., each data lane can send data from one die to the other, and vice versa). In some instances, a device package can implement a half-duplex (or semi-duplex) communication system where each data lane uses a single conductive trace that allows two dies to communicate with each other in one direction at a time, thus not simultaneously. In other instances, a device package can implement a full-duplex communication system where each data lane uses a pair of conductive traces that allow two dies to communicate with each other simultaneously (e.g., one conductive trace to send data and another conductive trace to receive data).

Some communication systems have multiple data lanes to enable high bandwidth performance from the device package. However, the number of data lanes that can be used is limited by the surface area of each die. For example, an interposer can be limited to only 20 full duplex data lanes (e.g., 40 conductive traces) due to the surface area of the die mounted on the interposer. In some instances, it may be desirable to reduce the number of conductive traces while maintaining the same maximum bandwidth between dies. In these instances, reducing the number of conductive traces opens up surface area on the dies for other components or reduces the complexity of fabricating the device package. In other instances, it may be desirable to increase the maximum possible bandwidth between a pair of dies while maintaining the same number of conductive traces.

Aspects and implementations of the present disclosure address the above deficiencies by implementing a high-bandwidth interconnect (e.g., interposer) having simultaneous bi-directional (SBD) data lanes. Each data lane can be configured to simultaneously transmit and receive data over a single conductive trace. In an illustrative example, each data lane can include pair of transceivers, where a first transceiver is part of a first die (e.g., die A) and a second transceiver is part of a second die (e.g., die B). Each transceiver can send data over the conductive trace and receive data over the conductive trace using source-synchronous clocking (e.g., forwarded clock). Source-synchronous clocking can refer to a technique having the transmitting die send a clock signal along with the data (e.g., data signals). The data received by each transceiver can be in the form of a combined signal (e.g., the waveform of the data sent combined with the waveform of the data received). Each respective transceiver can then subtract the waveform of the data sent from the combined signal, resulting in a waveform reflecting the data received. In some implementations, each transceiver can be configured (e.g., trained, calibrated, etc.) prior to transmitting data (e.g., during a boot process) to perform error correcting operations that account for variables (e.g., fluctuations, errors, etc.) that occur during the operations to split the combined signal.

Thus, by enabling simultaneous bi-directional data lanes, advantages of the disclosure include reducing (up to half) the number of conductive traces between two dies while maintaining the same maximum bandwidth. Advantages of the disclosure also enable doubling the maximum bandwidth between two dies while maintaining the same number conductive traces, or any combination thereof. Other advantages will be apparent to those skilled in the art of SBD-based transceiver interface design, as will be discussed hereinafter.

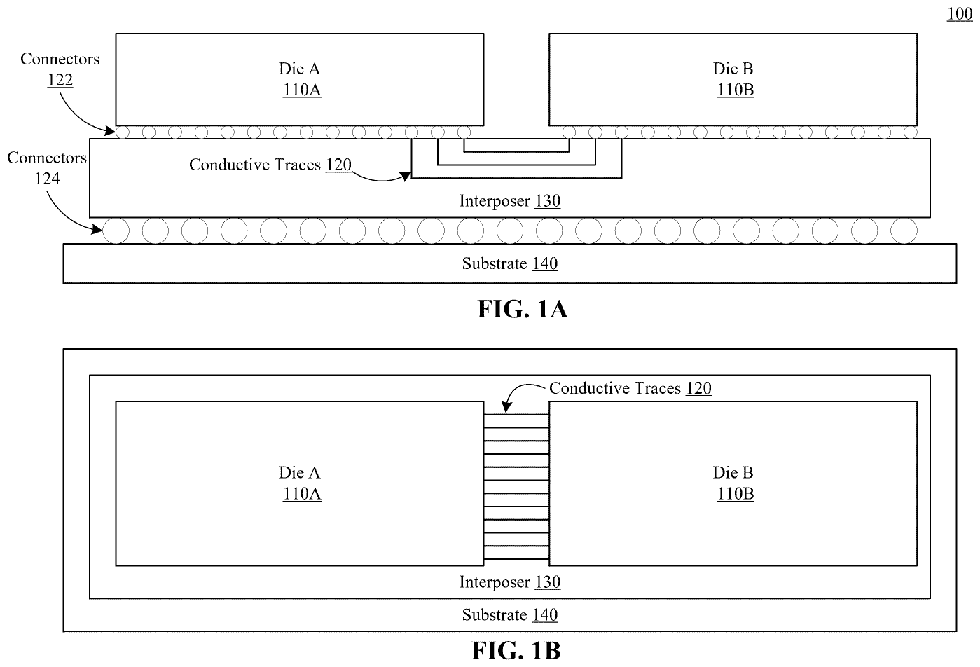

FIG. 1A is a schematic block diagram showing a schematic cross-sectional view of a communications system 100 configured to implement simultaneous bi-directional (SBD) data lanes, according to various implementations. FIG. 1B is a schematic block diagram showing a top view of communications system 100, according to various implementations. Communications system 100 can be a device package that includes die A 110A and die B 110B mounted on interposer 130, which is coupled to substrate 140. In some implementations, communications system 100 can be mounted, via substrate 140, onto a printed circuit board (not shown). Communications system 100 can be configured to electrically and/or mechanically connect die A 110A with die B 110B, as well as and any other logic or memory ICs mounted on interposer 130, to the printed circuit board or other mounting substrates external to communications system 100.

In some implementations, the communications system 100 includes a first integrated circuit (IC) chip or die (e.g., die A 110A) and a second IC chip or die (e.g., die B 110B) communicably connected by conductive traces 120. Each die 110A, 110B can be a computing device or processing device that processes data. For example, die 110A, 110B can be a computer processing unit (CPU), a graphics processing unit (GPU), a data processing unit (DPU), a neural processing unit (NPU), an application-specific integrated circuit (ASIC), a field programmable gate array (FPGA), a semiconductor chip, or the like. Illustrative examples of a semiconductor chip can include a memory chip, a global positioning system (GPS) chip, a radio frequency (RF) transceiver chip, a Wi-Fi chip, a system-on-chips (SoC), a 3D package (e.g., a system in a package (SiP), a chip stack, or any other set of vertically stacked chips), 3D integrated circuits, etc. These computing devices (e.g., die 110A, 110B) can be implemented as components in devices referred to as machines, computers, servers, network devices, or the like. It is noted that communications system 100 using two dies is by way of illustrative example, and that a primary die (e.g., die A 110A) can be connected to multiple secondary dies. In

Die A 110A and/or die B 110B can be coupled to (e.g., mounted on) interposer 130 using one or more connectors 122. Each connector 122 can be a solder joint (e.g., a solder ball or solder bump) or other electrical connection that provides contact between a respective electrical contact formed on the surface of die A 110A and/or die B 110B and on the surface of interposer 130. Die A 110A can be configured to receive and transmit input/output (I/O) signals directly to and from die B 110B (and vice versa) via conductive traces 120 in and/or on interposer 130.

Interposer 130 can be configured to form an intermediate layer or structure that provides electrical connections between die A 110A and/or die B 110B, and any other dies (not shown) mounted on interposer 130. Interposer 130 can further be configured to provide electrical connections between dies (e.g., die A 110A, die B 110B, etc.) mounted on interposer 130 and substrate 140. For example, interposer 130 can include one or more through-silicon vias (not shown) to carry signals between the dies and substrate 140. Through-silicon vias (or through-chip vias) can be (vertical) electrical connections that pass completely through interposer 130.

Conductive traces 120 are configured to electrically couple die A 110A and die B 110B to each other, and/or to other dies or components, such as substrate 140. Conductive traces 120 can be configured to facilitate the high-speed transfer of I/O signals between die A 110A and die B 110B. Conductive traces 120 can include wires, conductive layers, etc. that carry I/O signals between the die A 110A and die B 110B via respective I/O pins or pads of each die that are connected to the conductive trace. In some implementations, conductive traces 120 can be formed on or within interposer 130 using one or more film deposition, patterning, and/or etching techniques capable of forming electrical interconnects on semiconductor substrates. Thus, interposer 130 can include a set of closely spaced conductive traces 120 configured to provide a relatively high number of interconnects between die A 110A and die B 110B.

In some implementations, each (or some) of the conductive traces 120 can be coupled to a pair of transceivers to form a data lane configured to simultaneously transmit and receive data. Each data lane provides a high-speed pathway for communication between the die A 110A and die B 110B (e.g., each data lane can send data from one die to the other, and vice versa). To simultaneously transmit and receive data over a single conductive trace, each data lane can include pair of transceivers, where one transceiver is part of die A 110A and the other transceiver is part of die B 110B. This will be explained in detail below.

Interposer 130 can be coupled to (e.g., mounted on) substrate 140 using one or more connectors 124. Similar to connectors 122, each connector 124 can be a solder joint (e.g., a solder ball or solder bump) or other electrical connection that provides contact between a respective electrical contact formed on the surface of interposer 130 and on the surface of substrate 140.

Substate 140 can be a rigid and electrically insulating substrate on which interposer 130 is mounted. Substrate 140 can provide device package 100 with structural rigidity. In some implementations, substrate 140 is a laminate substrate and is composed of a stack of insulative layers or laminates that are built up on the top and bottom surfaces of a core layer. Package substrate 140 can also provide an electrical interface for routing I/O signals and power between die A 110A, die B 110B, and external electrical connections (not shown). These external electrical connections can be any technically feasible chip package electrical connection, such as, for example, a ball-grid array (BGA), a pin-grid array (PGA), and so forth.

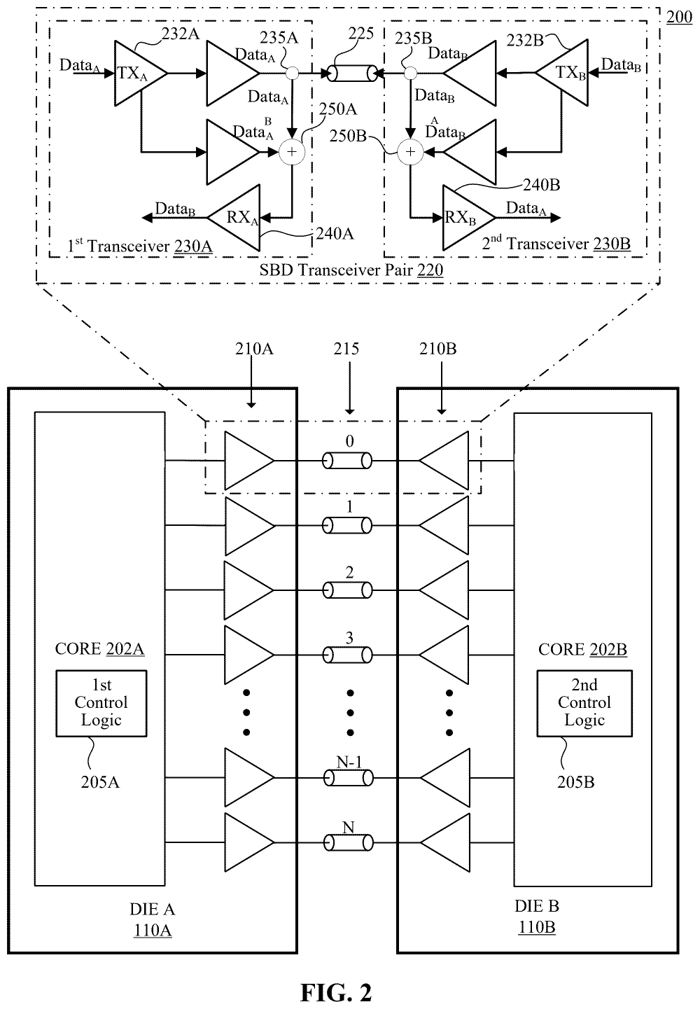

FIG. 2 is a schematic block diagram of an example simultaneous bi-directional (SBD) communications system 200 according to various implementations. System 200 includes die A 110A and die B 110B. In these implementations, die A 110A includes first processing core 202A having first control logic 205A, and die B 110B includes second processing core 202B having second control logic 205B. Further, die A 110A includes a first set of transceivers 210A coupled to first processing core 202A (and thus to the first control logic 105A), and die B 110B includes a second set of transceivers 210B coupled to second processing core 202B (and thus to second control logic 205B). In some implementations, although not illustrated, first control logic 205A is instead located between first processing core 202A and the first set of transceivers 210A, and second control logic 205B is instead located between second processing core 202B and the second set of transceivers 210B. In some implementations, one or more of first processing core 202A, second processing core 202B, die A 110A, and/or die B 110B are central processing units (CPUs), graphics processing units (GPUs), or data processing units (DPUs).

In some implementations, the system 200 further includes a set of channels 215 (e.g., data lanes formed by conductive traces) communicatively coupled between the first set of transceivers 110A and the second set of transceivers 110B, e.g., and thus between die A 110A and die B 110B. In some implementations, a communication interface (or data interface) is formed between die A 110A and die B 110B by the first and second set of transceivers 210A, 210B and the set of corresponding channels 215. In some implementations, the set of channels 215 are also referred to as data lanes. In some implementations, the second set of transceivers 210B are coupled in parallel to the first set of transceivers 210A over corresponding channels of the set of channels 215. Due to this coupling over a single channel, intercoupled transceivers of the first and second set of transceivers 210A and 210B are configured as simultaneous bi-directional (SBD) transceivers.

In some implementations, first control logic 205A is configured to determine and/or generate data to be passed over various ones of the first set of transceivers 210A. Similarly, in these implementations, second control logic 205B is configured to determine and/or generate data to be passed over various ones of the second set of transceivers 210B. In at least some implementations, first and second processing cores 202A, 202B control transitions between idle mode and transmission mode in terms of what data is being transmitted over which transceivers. In certain implementations, idle mode involves transmitting all the same values such as only ones or only zeros (sometimes referred to as dummy data) over the set of channels 215 or at least a subset of the set of channels 215. In transitioning to transmission mode, first processing core 202A and second processing core 202B begin to send meaningful data back and forth over the set of channels 215 via the first and second set of transceivers 210A, 210B, respectively.

In some implementations, because the first and second set of transceivers 210A, 210B form SBD transceiver pairs 220, each SBD transceiver pair 220 communicates over a single channel 225 that constitutes, for example, a full-duplex data lane over which data can be concurrently sent and received by either transceiver. For example, each SBD transceiver pair 220 can include first transceiver 230A coupled to second transceiver 230B over the channel 225.

In some implementations, first transceiver 230A includes first transmitter 232A that transmits first data (e.g., Data_{A} received from first processing core 202A), first receiver 240A that receives second data (e.g., Data_{B}) over the channel 225 from the second transceiver 230B, and splitter 250A coupled between first transmitter 232A, channel 225, and first receiver 240A. In some implementations, splitter 250A can include circuitry that facilitates the full-duplex nature of data communication between first and second transceivers 220A, 220B. For example, splitter 250A can cancel out interference of the first data being transmitted by first transmitter 232A when receiving the second data over the channel 225.

Similarly, in some implementations, second transceiver 230B includes a second transmitter 232B that transmits second data (e.g., Data_{B} received from the second processing core 202B), a second receiver 240A that receives first data (e.g., Data_{A}) over the channel 225 from the first transceiver 230A, and splitter 250B coupled between the second transmitter 232B, channel 225, and the second receiver 240B. In some implementations, the splitter 250B facilitates the full-duplex nature of data communication between the first and second transceivers 220A and 220B. For example, the splitter circuitry 250B may cancel out interference of the second data being transmitted by the second transmitter 232B when receiving the first data over the channel 225.

In some implementations, Data_{A} is sent by transmitter 232A to splitter 250A and to I/O pad 235A. I/O pads 235A, 235B can be contact pads that interface with transmitters 232A, 232B, channel 225, splitters 250A, 250B, or any other component of first transceiver 230A and/or second transceiver 230B. As Data_{A} is sent from I/O pad 235A to second transceiver 230B, Data_{B} can be received, via I/O pad 235A, from second transceiver 230B. As such, the data received by first transceiver 230A, via I/O pad 235A, can be in the form of a combined signal that includes both Data_{A} and Data_{B}. For example, since Data_{A} and Data_{B} is sent simultaneously by respective transmitters 232A, 232B, the waveform of the data sent (Data_{A}) is combined with the waveform of the data received (Data_{B}). The combined signal (Data_{AB}) is sent to splitter 250A, which also received Data_{A} from transmitter 232A. To cancel out the interference of Data_{A} when receiving Data_{B}, splitter 250A subtracts the waveform of Data_{A} from the waveform of Data_{AB}, resulting in a waveform reflecting Data_{B}. The extracted DataB is then received by receiver 240A, and forwarded to processing core 202A.

In some implementations, the waveform of Data_{A} sent to splitter 250A can be an inverse of the waveform of Data_{A}. For example, circuitry in transceiver 230A can inverse the waveform of Data_{A} and then send the inversed waveform to splitter 250A. As such, to cancel out the interference of Data_{A} when receiving Data_{B}, splitter 250A combines the inverse waveform of Data_{A} with the waveform of Data_{AB}, resulting in a waveform reflecting Data_{B}.

Similarly, in some implementations, Data_{B} is sent by transmitter 232B to splitter 250B and to I/O pad 235B. As Data_{B} is sent from I/O pad 235B to first transceiver 230A, Data_{A} can be received, via I/O pad 235B, from first transceiver 230A. As such, the data received by the second transceiver 230B, via I/O pad 235B, can be in the form of a combined signal that includes both Data_{A} and Data_{B}. For example, the waveform of the data sent (Data_{B}) is combined with the waveform of the data received (Data_{A}). The combined signal (Data_{BA}) is sent to splitter 250B, which also received Data_{B} from transmitter 232B. To cancel out the interference of Data_{B} when receiving Data_{A}, splitter 250B subtracts the waveform of Data_{B} from the waveform of Data_{BA}, resulting in a waveform reflecting Data_{A}. The extracted Data_{A} is then received by receiver 240B, and forwarded to processing core 202B. In some implementations, the waveform of Data_{B} sent to splitter 250B can be an inverse of the waveform of Data_{B}. For example, circuitry in transceiver 230B can inverse the waveform of Data_{B} and then send the inversed waveform to splitter 250B. As such, to cancel out the interference of Data_{B} when receiving Data_{A}, splitter 250B combines the inverse waveform of Data_{B} with the waveform of Data_{BA}, resulting in a waveform reflecting Data_{A}.

Transceiver 230A, 230B can send and receive data (Data_{A}, Data_{B}) over channel 225 using source-synchronous clocking (e.g., forwarded clock). Source-synchronous clocking can refer to a technique having transmitter 232A, 232B send a clock signal along with the transmitted data (e.g., Data_{A}, Data_{B}). Both transceivers 230A, 230B can have respective, synchronized clocks. For example, the respective clocks can be synchronized during a boot process. The clock signal can be used as a reference signal to maintain the timing relationship of the sent data during processing by respective receivers.

In some implementations, each transceiver can be configured prior to transmitting data to perform error correcting operations that account for variables that occur during the operations to split the combined signal. In some implementations, splitter 250A, 250B can be configurated (e.g., trained, calibrated, etc.) to reduce or remove any additional signals added to the combined signal. These additional signals can include noise, fluctuations, errors, etc. that can be absorbed by the combined signal during transmission. For example, during a boot process, Data_{A} can be combined with Data_{B} using separate channels and/or transmission times to generate a “clean” combined waveform. This clean combined waveform can be compared with the waveform of Data_{AB}, which is obtained using simultaneous bi-directional communication. The difference (referred to as a “delta value”) between the two waveforms is determined. If a delta value exists (e.g., a value that is not zero), then it can be determined that the simultaneous bi-directional communication introduced variables (e.g., noise, fluctuations, errors) into the combined waveform. Splitter 250A can be trained and/or calibrated to determine the type of variable introduced, the location in the waveform where the variable was introduced, which corrective waveform to apply to the combined waveform to remove the variable, etc. It is noted that this process can be performed multiple times (e.g., dozens, hundreds, thousands, etc.) to properly calibrated and/or train splitter 250A, 250B to remove possible variables.

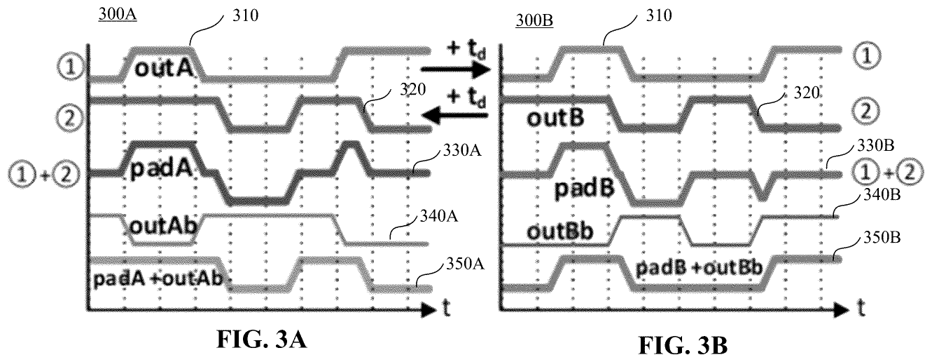

FIGS. 3A-3B are graphs 300A, 300B that illustrate example extraction operations performed by respective splitters, according to some implementations. In particular, graph 300A of FIG. 3A shows waveforms processed by transceiver 230A and graph 300B FIG. 3B shows waveforms processed by transceiver 230B. The y-axis shows waveforms over time. Waveform 310 reflects Data_{A} generated by transceiver 230A. In FIG. 3A, waveform 310 is generated by transceiver 230A and sent to transceiver 230B while in FIG. 3B, waveform 310 is received by transceiver 230B. Waveform 320 reflects Data_{B} generated by transceiver 230B. In FIG. 3A, waveform 320 is received by transceiver 230A while in FIG. 3B, waveform 320 is generated by transceiver 230B and sent to transceiver 230A.

Waveform 330A reflects the combined waveform of the data (Data_{A}) sent by transceiver 230A combined with the waveform of the data (Data_{B}) received by transceiver 230A (e.g., the waveform of Data_{AB}). Waveform 330B reflects the combined waveform of the data (Data_{B}) sent by transceiver 230B combined with the waveform of the data (Data_{A}) received by transceiver 230B (e.g., the waveform of Data_{BA}). Waveform 340A reflects the inverse of Data_{A}. Waveform 340B reflects the inverse of Data_{B}. Waveform 350A reflects canceling the interference of waveform 310 by combining waveform 340A (the inverse of Data_{A}) with waveform 330A (e.g., the waveform of Data_{AB}). Waveform 350B reflects canceling the interference of waveform 320 by combining waveform 340B (the inverse of Data_{B}) with waveform 330B (e.g., the waveform of Data_{BA}).

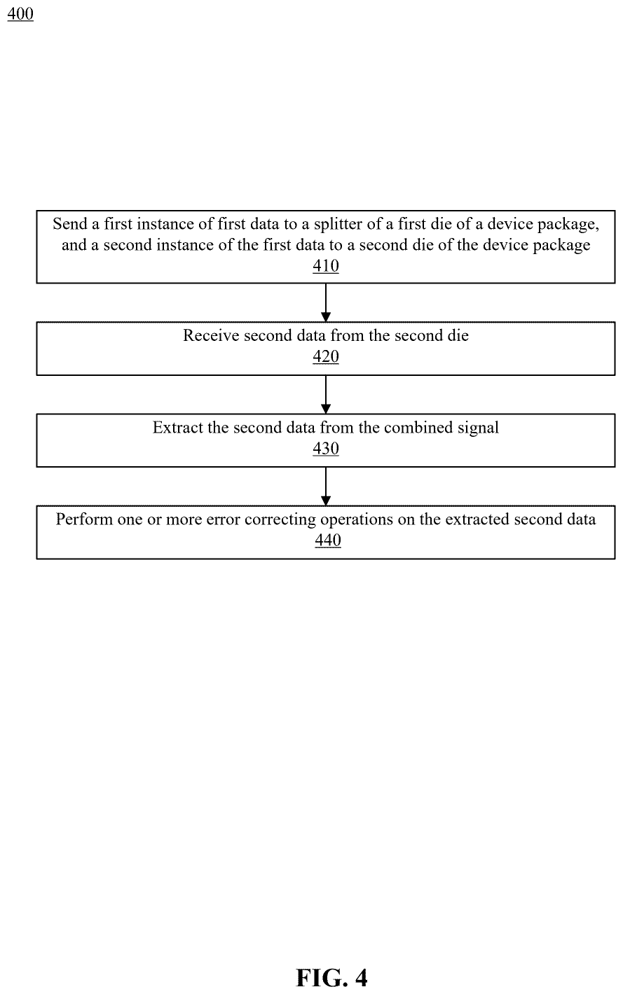

FIG. 4 is a flow chart of an example method 400 for extracting data from a combined signal, according to some implementations. Method 400 can be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an example, method 400 can be performed by transceiver 230A of FIG. 2.

Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 410, processing logic sends a first instance of first data to a splitter of a first die of a device package, and a second instance of the first data to a second die of the device package. The first instance of the first data can be sent to the second die via a conductive trace of an interposer. In some implementations, the instance of the second data can be an inverse (e.g., an inversed signal) of the second data. In some instances, the first instance of the second data can include a clock signal.

At operation 420, processing logic receives second data from the second die. The second data can be received over the conductive trace simultaneously with the first data being sent to the second die. Thus, the second data can be part of a combined signal that also include the first data.

At operation 430, processing logic extracts the second data from the combined signal. In some implementations, to extract the second data, the processing logic can subtract a signal (e.g., waveform) of the second instance of the first data from the combined signal. In some implementations, to extract the second data, the processing logic can combine the inverse signal of the second instance of the first data with the combined signal.

At operation 440, processing logic performs one or more error correcting operations on the extracted second data. The one or more error correcting operations can be used to reduce to eliminate noise, fluctuations, errors, etc. from the second data.

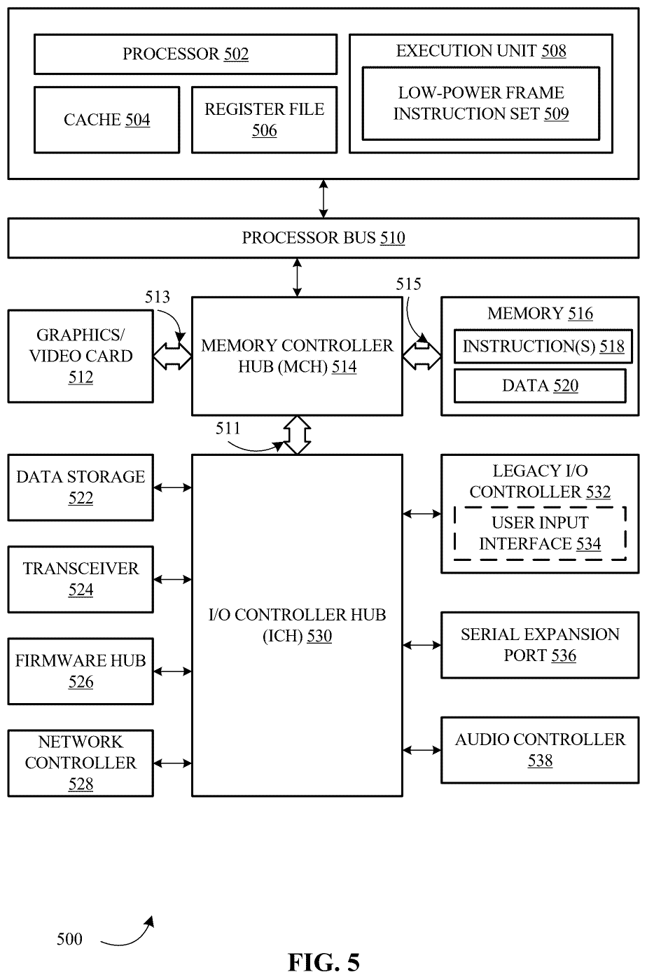

FIG. 5 is a block diagram illustrating an exemplary computer system, such as computer system 500, which can be a system with interconnected devices and components, a system-on-a-chip (SOC), or some combination thereof, according to aspects of the disclosure. In some implementations, computer system 500 can include, without limitation, a component, such as a processor 502 (e.g., a processing device), to employ execution units including logic to perform algorithms for process data, in accordance with the present disclosure, such as in the implementations described herein. In some implementations, computer system 500 can include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) can also be used. In some implementations, computer system 500 can execute a version of WINDOWS' operating system available from Microsoft Corporation of Redmond, Wash., although other operating systems (UNIX and Linux, for example), embedded software, and/or graphical user interfaces, can also be used.

Implementations can be used in other devices such as handheld devices and embedded applications. Some examples of handheld devices include cellular phones, Internet Protocol devices, digital cameras, personal digital assistants (PDAs), and handheld PCs. In some implementations, embedded applications can include a microcontroller, a digital signal processor (DSP), a system on a chip, network computers (NetPCs), set-top boxes, network hubs, wide area network (WAN) switches, or any other system that can perform one or more instructions in accordance with at least one implementation.

In some implementations, computer system 500 can include, without limitation, processor 502 that can include, without limitation, one or more execution units 508 to perform operations according to techniques described herein. In some implementations, computer system 500 is a single-processor desktop or server system, but in another implementation, the computer system 500 can be a multiprocessor system. In some implementations, processor 502 can include, without limitation, a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In some implementations, processor 502 can be coupled to a processor bus 510 that can transmit data signals between processor 502 and other components in computer system 500.

In some implementations, processor 502 can include, without limitation, a Level 1 (L1) internal cache memory (cache) cache 504. In some implementations, processor 502 can have a single internal cache or multiple levels of internal cache. In some implementations, the cache memory can reside external to processor 502. Other implementations can also include a combination of both internal and external caches depending on particular implementation and needs. In some implementations, register file 506 can store different types of data in various registers, including and without limitation, integer registers, floating-point registers, status registers, and instruction pointer registers.

In some implementations, an execution unit 508, including and without limitation, logic to perform integer and floating-point operations, also reside in processor 502. In some implementations, processor 502 can also include a microcode (μcode) read-only memory (ROM) that stores microcode for certain macro instructions. In some implementations, execution unit 508 can include logic to handle a low-power frame instruction set 509. In some implementations, by including low-power frame instruction set 509 in an instruction set of a general-purpose processor, such as processor 502, along with associated circuitry to execute instructions, operations used by many multimedia applications can be performed using packed data in a general-purpose processor, such as processor 502. In one or more implementations, many multimedia applications can be accelerated and executed more efficiently by using the full width of a processor's data bus for performing operations on packed data, which can eliminate the need to transfer smaller units of data across the processor's data bus to perform one or more operations one data element at a time.

In some implementations, execution unit 508 can also be used in microcontrollers, embedded processors, graphics devices, DSPs, and other types of logic circuits. In some implementations, computer system 500 can include, without limitation, a memory 516. In some implementations, memory 516 can be implemented as a Dynamic Random Access Memory (DRAM) device, a Static Random Access Memory (SRAM) device, a flash memory device, or other memory devices. In some implementations, memory 516 can store instruction(s) 518 and/or data 520 represented by data signals that can be executed by processor 502, which is operatively coupled to memory 516.

In some implementations, the system logic chip can be coupled to processor bus 510 and memory 516. In some implementations, the system logic chip can include, without limitation, a memory controller hub (MCH), such as MCH 514, and processor 502 can communicate with MCH 514 via processor bus 510. In some implementations, MCH 514 can provide a high bandwidth memory path 515 to memory 516 for instruction and data storage and for storage of graphics commands, data, and textures. In some implementations, MCH 514 can direct data signals between processor 502, memory 516, and other components in computer system 500 and bridge data signals between processor bus 510, memory 516, and a system input/output (I/O) 511. In some implementations, a system logic chip can provide a graphics port for coupling to a graphics controller. In some implementations, MCH 514 can be coupled to memory 516 through a high bandwidth memory path 515, and graphics/video card 512 can be coupled to MCH 514 through an Accelerated Graphics Port (AGP) interconnect 513.

In some implementations, computer system 500 can use the system I/O 511 that is a proprietary hub interface bus to couple the MCH 514 to I/O controller hub (ICH), such as ICH 530. In some implementations, ICH 530 can provide direct connections to some I/O devices via a local I/O bus. In some implementations, a local I/O bus can include, without limitation, a high-speed I/O bus for connecting peripherals to memory 516, chipset, and processor 502. Examples can include, without limitation, data storage 522, a transceiver 524, a firmware hub (flash Basic Input/Output System (BIOS)) 526, a network controller 528, a legacy I/O controller 532 containing a user input interface 534, a serial expansion port 536, such as Universal Serial Bus (USB), and an audio controller 538. In some implementations, data storage 522 can include a hard disk drive, a floppy disk drive, a compact disc read-only memory (CD-ROM) device, a flash memory device, or other mass storage devices.

In some implementations, FIG. 5 illustrates a computer system 500, which includes interconnected hardware devices or “chips,” whereas, in other implementations, FIG. 5 can illustrate an exemplary System on a Chip (SoC). In some implementations, devices can be interconnected with proprietary interconnects, standardized interconnects (e.g., Peripheral Component Interconnect buses (e.g., PCI, PCI Express)), or some combination thereof. In some implementations, one or more components of computer system 500 are interconnected using compute express link (CXL) interconnects.

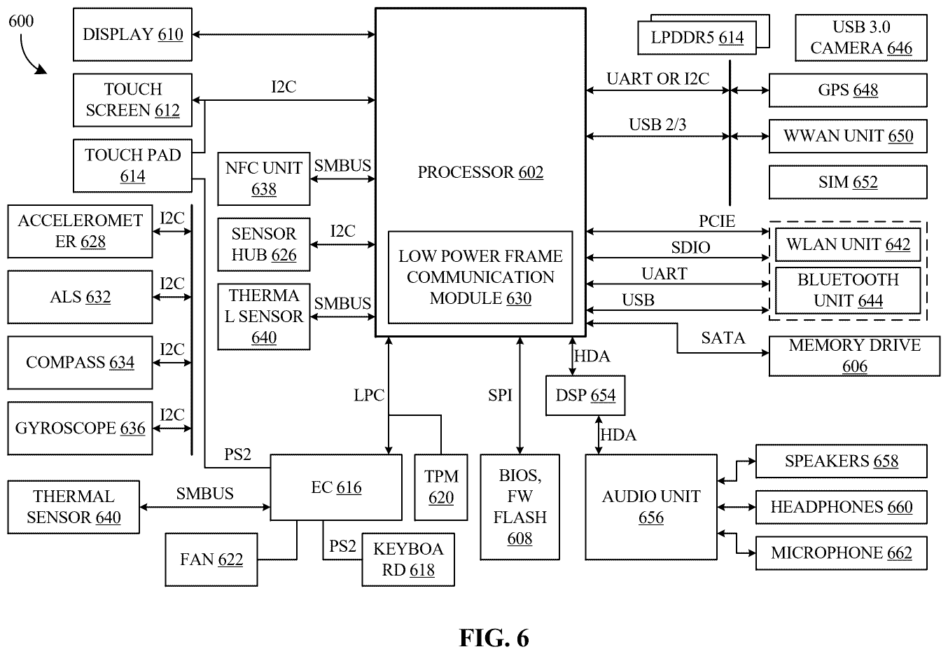

FIG. 6 is a block diagram illustrating an electronic device 600 for utilizing a processor 602, according to aspects of the disclosure. In some implementations, electronic device 600 can be, for example, and without limitation, a notebook, a tower server, a rack server, a blade server, a laptop, a desktop, a tablet, a mobile device, a phone, an embedded computer, or any other suitable electronic device.

In some implementations, electronic device 600 can include, without limitation, processor 602 communicatively coupled to any suitable number or kind of components, peripherals, modules, or devices. In some implementations, processor 602 coupled using a bus or interface, such as an Inter-Integrated Circuit (I2C) bus, a System Management Bus (SMBus), a Low Pin Count (LPC) bus, a Serial Peripheral Interface (SPI), a High Definition Audio (HDA) bus, a Serial Advance Technology Attachment (SATA) bus, a Universal Serial Bus (USB) (including USB 1.0/1/1, USB 2.0, USB 3.0/3.1 Gen1/3.1 Gen2, and USB4), or a Universal Asynchronous Receiver/Transmitter (UART) bus. In some implementations, FIG. 6 illustrates a system, which includes interconnected hardware devices or “chips,” whereas in other implementations, FIG. 6 can illustrate an exemplary System on a Chip (SoC). In some implementations, devices illustrated in FIG. 6 can be interconnected with proprietary interconnects, standardized interconnects (e.g., Peripheral Component Interconnect Express (PCIe)), or some combination thereof. In some implementations, one or more components of FIG. 6 are interconnected using compute express link (CXL) interconnects.

In some implementations, FIG. 6 can include a display 610, a touch screen 612, a touch pad 614, a Near Field Communications unit (NFC) 638, a sensor hub 626, a thermal sensor 640, an Express Chipset (EC), such as EC 616, a Trusted Platform Module (TPM), such as TPM 620, BIOS/firmware (FW)/flash memory, such as BIOS, FW Flash 608, a DSP 664, a memory drive 606 such as a Solid State Disk (SSD) or a Hard Disk Drive (HDD), a wireless local area network unit (WLAN), such as WLAN unit 642, a Bluetooth unit 644, a Wireless Wide Area Network unit (WWAN), such as WWAN unit 650, a Global Positioning System (GPS) 648, a camera (USB 3.0 camera) 646, such as a USB 3.0 camera, and/or a Low Network bandwidth Double Data Rate (LPDDR) memory unit, such as LPDDR5 604 implemented in, for example, LPDDR5 standard. These components can each be implemented in any suitable manner.

In some implementations, other components can be communicatively coupled to processor 602 through the components discussed above. In some implementations, processor 602 can include a low-power frame transmission module 630. In some implementations, an accelerometer 628, Ambient Light Sensor (ALS), such as ALS 632, compass 634, and a gyroscope 636 can be communicatively coupled to sensor hub 626. In some implementations, thermal sensor 640, a fan 622, a keyboard 618, and a touch pad 614 can be communicatively coupled to EC 616. In some implementations, speakers 658, headphones 660, and microphone 662 can be communicatively coupled to an audio unit 656 which can, in turn, be communicatively coupled to DSP 654. In some implementations, audio unit 656 can include, for example, and without limitation, an audio coder/decoder (codec) and a class-D amplifier. In some implementations, a subscriber identification module (SIM) card, such as SIM 652 can be communicatively coupled to WWAN unit 650. In some implementations, components such as WLAN unit 642 and Bluetooth unit 644, as well as WWAN unit 650 can be implemented in a Next Generation Form Factor (NGFF).

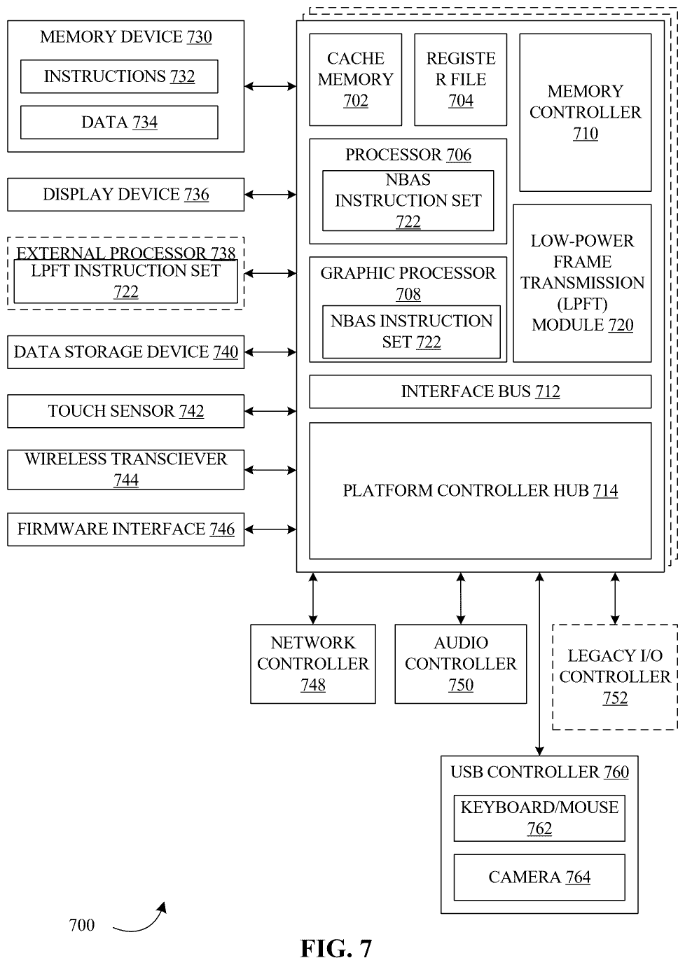

FIG. 7 is a block diagram of a processing system 700, according to aspects of the disclosure. In some implementations, the processing system 700 includes cache memory 702, register file 704, processors 706, graphics processors 708, memory controller 710, interface bus 712, platform controller hub 714, and low-power frame transmission module 720. Processing system 700 can be a single processor desktop system, a multiprocessor workstation system, or a server system having a large number of processors 706 or graphics processors 708. In some implementations, the processing system 700 is a processing platform incorporated within a system-on-a-chip (SoC) integrated circuit for use in mobile, handheld, or embedded devices.

In some implementations, the processing system 700 can include, or be incorporated within a server-based gaming platform, a game console, including a game and media console, a mobile gaming console, a handheld game console, or an online game console. In some implementations, the processing system 700 is a mobile phone, smart phone, tablet computing device, or mobile Internet device. In some implementations, the processing system 700 can also include, couple with, or be integrated within, a wearable device, such as a smart watch wearable device, smart eyewear device, augmented reality device, or virtual reality device. In some implementations, the processing system 700 is a television or set-top box device having one or more processors 706 and a graphical interface generated by one or more graphics processors 708.

In some implementations, one or more processors 706 each include one or more of the processor cores to process instructions which, when executed, perform operations for system and user software. In some implementations, one or more processors 706 and/or one or more graphics processors can be configured to process a portion of the low-power frame transmission (LPFT) instruction set, such as LPFT instruction set 722. In some implementations, LPFT instruction set 722 can facilitate Complex Instruction Set Computing (CISC), Reduced Instruction Set Computing (RISC), or computing via a Very Long Instruction Word (VLIW). In some implementations, processor cores can each process a different instruction set from LPFT instruction set 722, which can include instructions to facilitate emulation of other instruction sets (not illustrated). In some implementations, processor cores can also include other processing devices, such as a Digital Signal Processor (DSP).

In some implementations, processors 706 includes cache memory 702. In some implementations, processors 706 can have a single internal cache or multiple levels of internal cache. In some implementations, cache memory 702 is shared among various components of processors 706. In some implementations, processors 706 also uses an external cache (e.g., a Level 3 (L3) cache or Last Level Cache (LLC)) (not illustrated), which can be shared among processor cores using known cache coherency techniques. In some implementations, register file 704 is additionally included in processors 706, which can include different types of registers for storing different types of data (e.g., integer registers, floating-point registers, status registers, and an instruction pointer register). In some implementations, register file 704 can include general-purpose registers or other registers.

In some implementations, one or more processors 706 are coupled with one or more interface bus 712 to transmit communication signals such as address, data, or control signals between processor cores and other components in processing system 700. In some implementations, interface bus 712, in one implementation, can be a processor bus, such as a version of a Direct Media Interface (DMI) bus. In some implementations, interface bus 712 is not limited to a DMI bus, and can include one or more PCI buses (e.g., PCI, PCI Express), memory busses, or other types of interface busses. In some implementations, processors 706 include an integrated memory controller (e.g., memory controller 710) and a platform controller hub 714 (PCH). In some implementations, memory controller 710 facilitates communication between a memory device and other components of the processing system 700, while platform controller hub 714 provides connections to I/O devices via a local I/O bus.

In some implementations, the memory device 730 can be a dynamic random-access memory (DRAM) device, a static random-access memory (SRAM) device, a flash memory device, a phase-change memory device, or some other memory device having suitable performance to serve as process memory. In some implementations, the memory device 730 can operate as system memory for processing system 700 to store instructions 732 and data 734 for use when one or more processors 706 executes an application or process. In some implementations, memory controller 710 also optionally couples with an external processor 738, which can communicate with one or more graphics processors 708 in processors 706 to perform graphics and media operations. In some implementations, a display device 736 can connect to processors 706. In some implementations, the display device 736 can include one or more of an internal display device, as in a mobile electronic device or a laptop device, or an external display device attached via a display interface (e.g., DisplayPort, etc.). In some implementations, display device 736 can include a head-mounted display (HMD) such as a stereoscopic display device for use in virtual reality (VR) applications or augmented reality (AR) applications.

In some implementations, the platform controller hub 714 enables peripherals to connect to memory device 730 and processors 706 via a high-speed I/O bus. In some implementations, I/O peripherals include, but are not limited to, a data storage device 740 (e.g., hard disk drive, flash memory, etc.), a touch sensor 742, a wireless transceiver 744, firmware interface 746, a network controller 748, or an audio controller 750.

In some implementations, the data storage device 740 can connect via a storage interface (e.g., SATA) or via a peripheral bus, such as a PCI bus (e.g., PCI, PCI Express). In some implementations, touch sensor 742 can include touch screen sensors, pressure sensors, or fingerprint sensors. In some implementations, wireless transceiver 744 can be a Wi-Fi transceiver, a Bluetooth transceiver, or a mobile network transceiver such as a 3G, 4G, Long Term Evolution (LTE), 5G, or 6G transceiver. In some implementations, firmware interface 746 enables communication with system firmware and can be, for example, a unified extensible firmware interface (UEFI). In some implementations, the network controller 748 can enable a network connection to a wired network. In some implementations, a high-performance network controller (not illustrated) couples with interface bus 712. In some implementations, audio controller 750 can be a multi-channel high-definition audio controller. In some implementations, the processing system 700 includes an optional legacy I/O controller 752 for coupling legacy (e.g., Personal System-2 (PS/2)) devices to the processing system 700. In some implementations, the platform controller hub 714 can also connect to one or more Universal Serial Bus (USB) controllers, such as USB controller 760 to connect input devices, such as a keyboard and mouse combination (keyboard/mouse 762), a camera 764, or other USB input devices.

In some implementations, an instance of memory controller 710 and platform controller hub 714 can be integrated into a discreet external graphics processor, such as external processor 738. In some implementations, the platform controller hub 714 and/or memory controller 710 can be external to one or more processors 706. For example, in some implementations, the processing system 700 can include an external memory controller (e.g., memory controller 710) and the platform controller hub 714, which can be configured as a memory controller hub and peripheral controller hub within a system chipset that is in communication with the processors 706.

Other variations are within the spirit of the present disclosure. Thus, while disclosed techniques are susceptible to various modifications and alternative constructions, certain illustrated implementations thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed implementations (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain implementations require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some implementations, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some implementations, code is stored on a computer-readable storage medium, for example, in form of a computer program comprising a plurality of instructions executable by one or more processors. In some implementations, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some implementations, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some implementations, comprises multiple non-transitory computer-readable storage media and one or more of individual non-transitory storage media of multiple non-transitory computer-readable storage media lacks all of the code while multiple non-transitory computer-readable storage media collectively store all of the code. In some implementations, executable instructions are executed such that different instructions are executed by different processors—for example, a non-transitory computer-readable storage medium stores instructions, and a main central processing unit (CPU) executes some of the instructions while a graphics processing unit (GPU) executes other instructions. In some implementations, different components of a computer system have separate processors, and different processors execute different subsets of instructions.

Accordingly, in some implementations, computer systems are configured to implement one or more services that singly or collectively perform operations of processes described herein, and such computer systems are configured with applicable hardware and/or software that enable the performance of operations. Further, a computer system that implements at least one implementation of present disclosure is a single device and, in another implementation, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate implementations of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A first device comprising:
a transceiver to communicate with a second device over an interposer, the interposer comprising a plurality of conductive traces between respective transceivers of the first device and the second device; and
control logic, coupled to the transceiver, configured to:
send first data to the second device over a conductive trace of the plurality of conductive traces;
simultaneously receive second data from the second device over the conductive trace; and
extract the second data from a combined signal comprising the first data and the second data.

2. The first device of claim 1, wherein the control logic is further configured to:
subtract a waveform associated with the first data from a waveform associated with the second data to extract the second data from the combined signal.

3. The first device of claim 1, wherein the control logic is further configured to:
generate an inverse waveform associated with the first data; and
combine the inverse waveform with a waveform associated with the second data to extract the second data from the combined signal.

4. The first device of claim 1, wherein the control logic is further configured to:
perform one or more error correcting operations on a waveform obtained from the combined signal.

5. The first device of claim 1, wherein the first data is sent along with a clock signal.

6. The first device of claim 1, wherein the control logic is further configured to:
configure, during a boot process, the transceiver to remove additional signal added to the combined signal during transmission.

7. The first device of claim 1, wherein the control logic, to calibrate the transceiver, is to:
generate a first combined waveform comprising third data generated by the first device and fourth data generated by the second device;
generate a second combined waveform comprising fifth data generated by the first device and sixth data generated by the second device;
determine a delta value between the first combined waveform and the second combined waveform; and
determine a corrective waveform to apply to the second combined waveform.

8. A method, comprising:
sending, from a first device, first data to a second device over a conductive trace of a plurality of conductive traces between the first device and the second device;
simultaneously receiving second data from the second device over the conductive trace; and
extracting the second data from a combined signal comprising the first data and the second data.

9. The method of claim 8, further comprising:
subtracting a waveform associated with the first data from a waveform associated with the second data to extract the second data from the combined signal.

10. The method of claim 8, further comprising:
generate an inverse waveform associated with the first data; and
combine the inverse waveform with a waveform associated with the second data to extract the second data from the combined signal.

11. The method of claim 8, further comprising:
performing one or more error correcting operations on a waveform obtained from the combined signal.

12. The method of claim 8, wherein the first data is sent along with a clock signal.

13. The method of claim 8, further comprising:
configuring, during a boot process, the transceiver to remove additional signal added to the combined signal during transmission.

14. The method of claim 8, wherein the calibrating is performed by:
generating a first combined waveform comprising third data generated by the first device and fourth data generated by the second device;
generating a second combined waveform comprising fifth data generated by the first device and sixth data generated by the second device;
determining a delta value between the first combined waveform and the second combined waveform; and
determining a corrective waveform to apply to the second combined waveform.

15. A system, comprising:
a first device comprising a first transceiver;
a second device comprising a second transceiver; and
an interposer comprising a conductive trace to carry data between the first transceiver and the second transceiver, wherein the first transceiver is configured to simultaneously transmit data to and receive data from the second transceiver by performing operations comprising:
sending first data to the second transceiver over the conductive trace;
simultaneously receiving second data from the second transceiver over the conductive trace; and
extracting the second data from a combined signal comprising the first data and the second data.

16. The system of claim 15, wherein the operations further comprise:
subtracting a waveform associated with the first data from a waveform associated with the second data to extract the second data from the combined signal.

17. The system of claim 15, wherein the operations further comprise:
generating an inverse waveform associated with the first data; and
combining the inverse waveform with a waveform associated with the second data to extract the second data from the combined signal.

18. The system of claim 15, wherein the operations further comprise:
performing one or more error correcting operations on a waveform obtained from the combined signal.

19. The system of claim 15, wherein the first data is sent along with a clock signal.

20. The system of claim 15, wherein the operations further comprise:
configuring, during a boot process, the transceiver to remove additional signal added to the combined signal during transmission.
